(19) United States
(12) Patent Application Publication
(10) Pub. No.: US 2008/0084940 A1
(43) Pub. Date: Apr. 10, 2008

(54) OFDM receiver

(75) Inventor: Wen-Sheng Hou, Chung Li City (TW)

Correspondence Address: BIRCH STEWART KOLASCH & BIRCH, PO BOX 747, FALLS CHURCH, VA, 22040-0747, US

(73) Assignee: SILICON INTEGRATED SYSTEMS CORP.

(21) Appl. No.: 11/542,189

(22) Filed: Oct. 4, 2006

(51) Int. Cl. H04K 1/10

(52) U.S. Cl. 375/260

(57) ABSTRACT

An OFDM receiver includes a CCI detector and a frequency-domain notch filter. The CCI detector detects whether or not the co-channel interference exists in a sub-carrier and lowers the weight of a distorted sub-carrier to eliminate the influence of the co-channel interference. The frequency-domain notch filter receives a frequency-domain signal and generates a notched frequency-domain signal.

### BACKGROUND OF THE INVENTION

(a) Field of the Invention

The invention relates to an orthogonal frequency division multiplexing (OFDM) receiver, and particularly to an OFDM receiver used in a digital video broadcasting-terrestrial (DVB-T) system.

(b) Description of the Related Art

In the field of digital communication, a modulation technique called code orthogonal frequency division multiplexing (COFDM) is widely used in various applications.

FIG. 1 shows a schematic diagram illustrating a digital video broadcasting-terrestrial (DVB-T) system 10 that involves digital terrestrial transmission (DTT). The DVB-T system 10 includes an OFDM transmission system 11 and an OFDM receiver 12. During the terrestrial transmission of the DVB-T system 10, multi-path fading and co-channel interference (CCI) often occur and result in distortions of the emitted signal s(t). For instance, as shown in FIG. 2A, when an analogy broadcasting TV signal and an OFDM signal s(t) coexist in the same band, the two signals may interfere with each other to cause a distorted CCI waveform shown in FIG. 2B.

Since the CCI is typically a kind of narrow-band interference, one may use a time-domain notch filter 121 of the OFDM receiver 12 to eliminate it in time-domain. However, it is difficult to predict the occurrence of the CCI as well as to recognize spectrum of the CCI in the OFDM receiver 12, and the OFDM transmission system 11 may transmit the emitted signal s(t) in a multi-path fading channel. Hence, it is hard to design a suitable time-domain notch filter 121 and thus difficult to improve the reception performance of the DVB-T system 10.

### BRIEF SUMMARY OF THE INVENTION

Hence, an object of the invention is to provide an OFDM receiver for a DVB-T system free from the influence of co-channel interference (CCI).

According to one embodiment of this invention, an orthogonal frequency division multiplexing (OFDM) receiver includes a co-channel interference (CCI) detector and a frequency-domain notch filter. The CCI detector is used for receiving a frequency-domain signal that comprises a plurality of sub-carriers in frequency-domain and for generating an estimated error, where the sub-carriers comprises a plurality of scattered pilots, and the estimated error is calculated out from a first scattered pilot and a second scattered pilot spaced a pre-set time span apart the first scattered pilot in the same sub-carrier. The estimated error is compared with a pre-set threshold to generate a comparison result. The frequency-domain notch filter is used for receiving the frequency-domain signal and generating a notched frequency-domain signal according to the comparison result, where the notched frequency-domain signal has a plurality of sub-carriers and each sub-carrier contains notched frequency-domain data. When the estimated error is larger than the pre-set threshold, the frequency-domain notch filter lowers the weighting coefficient of the sub-carrier that contains the select first and second scattered pilots and/or the weighting coefficient of its adjacent sub-carrier. In comparison, when the estimated error is smaller than the pre-set threshold, the frequency-domain notch filter sets the weighting coefficient of the sub-carrier that contains the select first and second scattered pilots and/or the weighting coefficient of its adjacent sub-carrier as 1.

Through the design of this invention, the CCI detector of the OFDM receiver may effectively detect whether or not the co-channel interference exists in a sub-carrier, and the weight of a distorted sub-carrier (channel) and/or the weight of its adjacent possibly distorted sub-carrier (channel) are decreased to eliminate the influence of the co-channel interference.

Further, another embodiment of this invention also provides a method for detecting the co-channel interference (CCI). The method includes the following steps:

Receiving a frequency-domain signal that comprises a plurality of sub-carriers in frequency-domain; calculating an estimated error out from a first scattered pilot and a second scattered pilot spaced a pre-set time span apart the first scattered pilot in the same sub-carrier; and adjusting the weighting coefficient of the sub-carrier that contains the select first and second scattered pilots and/or the weighting coefficient of its adjacent sub-carrier according to the estimated error.

### BRIEF DESCRIPTION OF THE DRAWINGS

FIG. 1 shows a schematic diagram illustrating a conventional digital video broadcasting-terrestrial (DVB-T) system.

FIG. 2A shows a waveform diagram of an analogy broadcasting TV signal and an OFDM signal.

FIG. 2B shows a waveform diagram of co-channel interference.

FIG. 3A shows a schematic diagram illustrating a conventional DVB-T transmitter.

FIG. 3B shows a schematic diagram illustrating a frame structure in data transmission of a conventional DVB-T system.

FIG. 3C shows a schematic diagram illustrating a DVB-T receiver of the invention.

FIG. 4A shows a waveform diagram corresponding to a weighting coefficient setting of the invention.

FIG. 4B shows a waveform diagram corresponding to another weighting coefficient setting of the invention.

FIG. 5 shows a flowchart illustrating a method for detecting the co-channel interference according to an embodiment of the invention.

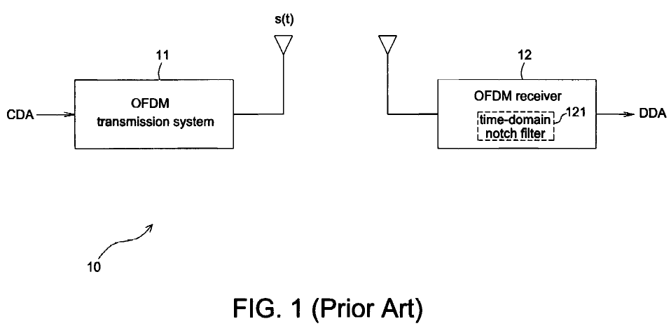

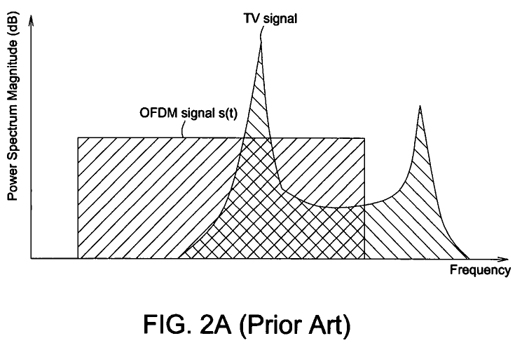

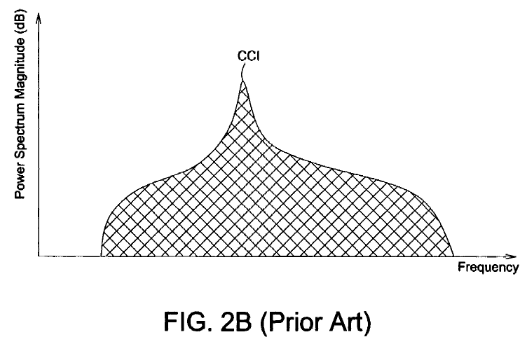

### DETAILED DESCRIPTION OF THE INVENTION

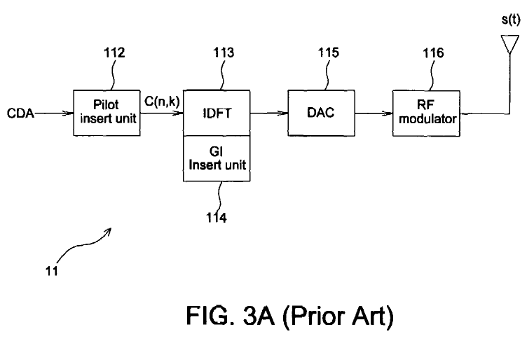

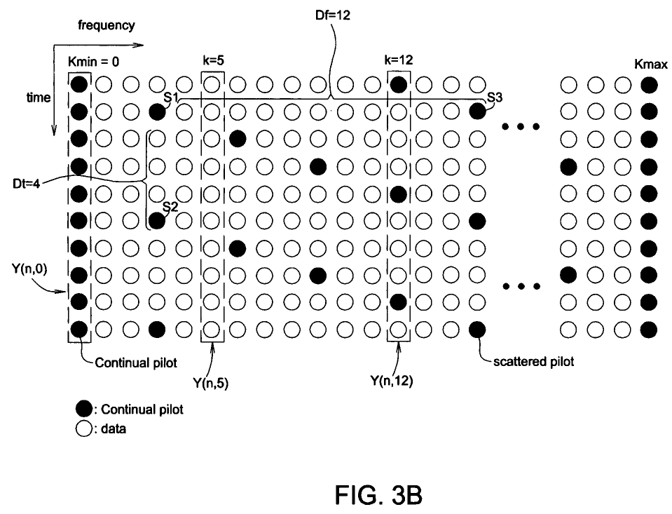

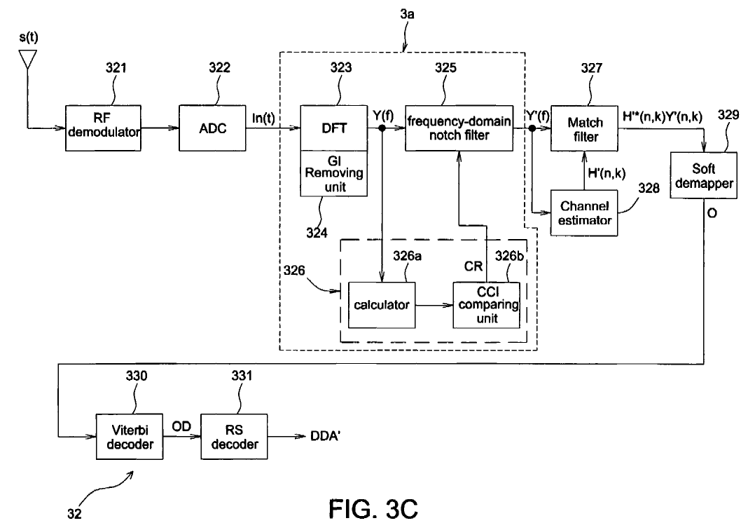

FIG. 3C shows a block diagram illustrating a digital video broadcasting-terrestrial (DVB-T) receiver 32 of the invention, and FIG. 3A shows a block diagram illustrating a conventional DVB-T transmitter 11. A DVB-T system generally includes the DVB-T transmitter 11 and the DVB-T receiver 32 that both operate in OFDM transmission with inner conventional codes, outer Reed-Solomon (RS) codes, and different modulation constellation choices (such as QPSK, 16 QAM and 64 QAM).

Referring to FIG. 3A, the DVB-T transmitter 11 includes a pilot insert unit 112, an inverse discrete Fourier transform (IDFT) circuit 113, a guard interval (GI) insert unit 114, a digital-to-analog converter (DAC) 115, and a RF modulator 116. The pilot insert unit 112 receives encoded data CDA and then inserts continual pilots or scattered pilots into the encoded data CDA in a pre-set manner to generate a transmission symbol C(n,k). Then, the pilot insert unit 112 outputs the transmission symbol C(n,k) to the IDFT circuit 113 to perform an inverse Fourier transformation, so that the frequency-domain data signal is transformed into a time-domain data signal. The GI insert unit 114 inserts guard interval into IDFT output of the IDFT circuit 113 so as to provide the resistance to the multi-path fading. Then, the DAC 115 performs a digital-to-analog conversion on the processed signal, and the converted signal is modulated by the RF modulator 116 to finally generate an emitted signal s(t) that is emitted by an antenna.

The emitted signal s(t) is an OFDM signal that includes a great number of separately-modulated sub-carriers, and the sub-carriers may be expressed as kε[Kₘᵢₙ;Kₘₐₓ]. Referring to FIG. 3B, for example, the value of Kmin is set as 0, and the value of Kmax equals 1704 in a 2 k mode and 6816 in a 8 k mode, respectively. Also, the dedicated synchronization symbols p(n,k) are embedded into the OFDM data stream (the emitted signal s(t)). As shown in FIG. 3B, the number of continual pilot sub-carriers train symbols equals 45 in a 2 k mode and 177 in an 8 k mode. Further, the scattered pilot cells train symbols form a periodic pattern where the arrangement of the scattered pilot symbols is repeated at a time span Dt=4 (between S1 and S2) and at a frequency interval Df=12 (between S1 and S3). Both continual and scattered pilot symbols are transmitted at a boosted power level, thus the corresponding modulation p(n,k)=± 4/3.

The emitted signal s(t) is given by:

$$s ( t ) = Re \{ {e}^{j2π {f}_{{c}^{t}}} {\sum }_{n = 0}^{∞} {\sum }_{k = {k}_{min}}^{{K}_{max}} {c}_{n , k} {ψ}_{n , k} ( t ) \}$$

$$where {ψ}_{n , k} ( t ) = \{ \begin{matrix}{e}^{j2π \frac{{k}^{′}}{{T}_{u}} ( t - Δ - {nT}_{s} )} & {nT}_{s} \leq t \leq ( n + 1 ) {T}_{s} \\ 0 & else\end{matrix} ,$$

where k denotes the sub-carrier number; n denotes the OFDM symbol number; Ts is the symbol duration; Tu is the inversed sub-carrier spacing;

Δ is the duration of the guard interval; fc is the central frequency of the RF signal; k′ is the sub-carrier index relative to the center frequency (k′=k−(Kmax+Kmin)/2); C(n,k) is the transmission symbol.

Next, referring to FIG. 3C, the DVB-T receiver 32 of an embodiment of this invention includes a RF demodulator 321, an analog-to-digital converter (ADC) 322, an OFDM receiver 3a, a match filter 327, a channel estimator 328, a soft demapper 329, a Viterbi decoder 330 and a Reed-Solomon (RS) decoder 331. The OFDM receiver 3a includes a discrete Fourier transform (DFT) circuit 323, a guard interval (GI) removing unit 324, a frequency-domain notch filter 325, and a CCI detector 326. The CCI detector 326 includes a calculator 326a and a CCI comparing unit 326b.

The RF demodulator 321 receives the emitted signal s(t) from the DVB-T transmitter 11 via an antenna and then performs signal demodulation, and the ADC 322 performs an analog-to-digital conversion on the demodulated signal s(t) to generate an input signal In(t) that includes multiple sub-carriers in time-domain.

The operations of the OFDM receiver 3a are described in detail below.

First, the DFT circuit 323 receives the input signal In(t) and generates a frequency-domain signal Y(f) that includes multiple sub-carriers in frequency domain. The frequency-domain data of each sub-carrier (channel) in the frequency-domain signal Y(f) are expressed as Y(n,k), where n and k are positive integers. Specifically, the frequency-domain data Y(n,k) may contain multiple pre-set continual pilots such as Y(n,0) at Kₘᵢₙ=0 shown in FIG. 3B, or the frequency-domain data Y(n,k) may contain no pilots such as Y(n,5) at K=5 shown in FIG. 3B. Alternatively, the frequency-domain data Y(n,k) may contain multiple pre-set scattered pilots such as Y(n,12) at K=12 shown in FIG. 3B. Certainly, the arrangement of continual pilots and scattered pilots is arbitrarily selected to conform to any design demand. The frequency-domain data Y(n,k) can be expressed as:

Y(n,k)=H(n,k)C(n,k)+I(n,k), for nth OFDM symbol, kth subcarrier (1)

where H(n,k) is the channel response in frequency-domain, C(n,k) is the transmission data, and I(n,k) is the CCI.

The GI removing unit 324 is used to remove the guard interval in the time-domain signal In(t), and the CCI detector 326 detects the CCI energy of the scatter pilots of the frequency-domain signal Y(f). In one embodiment, the CCI detector 326 receives the frequency-domain signal Y(f) and performs later described operations on two scattered pilots, such as the scattered pilot S1 and S2 shown in FIG. 3B, which are selected in the same sub-carrier (channel) and spaced a pre-set time span Dt apart from each other (i.e. having different symbols) to generate an estimated error ξ(k). The estimated error ξ(k) is compared with a pre-set threshold TH to obtain a comparison result CR. The estimated error ξ(k) is obtained by the calculator 326a through the operations of calculating the square of the absolute value of the difference between frequency-domain data Y(n,k) and Y(n-Dt,k), with the frequency-domain data Y(n,k) and Y(n-Dt,k) respectively contain the two different scattered pilots. Since the two scattered pilots are in the same sub-carrier and thus carry identical data, the transmission data terms C(n,k) and C(n-Dₜ,k) respectively for the two scattered pilots are identical. Thus, the square of the absolute value of the difference between frequency-domain data Y(n,k) and Y(n-Dt,k) is substantially equal to that between I(n,k) and I(n-Dt,k). Thus, the estimated error ξ(k) can be written:

$$\begin{matrix}ξ ( k ) = E \{ {\vert Y ( n , k ) - Y ( n - {D}_{t} , k ) \vert}^{2} \} , \\ for scattered pilot , C ( n , k ) = C ( n - {D}_{t} , k ) \\ \approx E \{ {\vert I ( n , k ) - I ( n - {D}_{t} , k ) \vert}^{2} \}\end{matrix} \qquad ( 2 )$$

Further, in order to obtain a more accurate estimated error ξ(k), the calculator 326a may perform the above operations on a select scattered pilot and any scattered pilot spaced the pre-set time span Dt apart the select scattered pilot to obtain multiple error values, and the multiple error values are then averaged to obtain an averaged estimated error ξ(k) to improve the CCI detection accuracy. Hence, in one embodiment, the CCI comparing unit 326b may compare a single estimated error ξ(k) with the pre-set threshold TH; while in an alternate embodiment, the CCI comparing unit 326b may compare an averaged estimated error ξ(k) with the pre-set threshold TH.

The frequency-domain notch filter 325 is a one-tap filter for each sub-carrier. Based on the above comparison result CR, the frequency-domain notch filter 325 may lower the weighting coefficient of the sub-carrier containing the scattered pilot and/or the weighting coefficient of its adjacent sub-carrier when the estimated error ξ(k) is larger than the pre-set threshold (i.e. the sub-carrier and/or its adjacent sub-carrier are distorted by CCI); in comparison, the frequency-domain notch filter 325 may set the weighting coefficient of the sub-carrier containing the scattered pilot and/or the weighting coefficient of its adjacent sub-carrier as 1 (or increase the weighting coefficient) when the estimated error ξ(k) is smaller than the pre-set threshold. Thus, the frequency-domain notch filter 325 is able to eliminate the influence of the CCI.

For example, assume the weighting coefficient of the frequency-domain notch filter 325 is denoted as M(k), the frequency-domain notch filter 325 may operate conforming to the equation written below:

$$\{ \begin{matrix}0 \leq M ( k ) < 1 & if ξ ( k ) > TH \\ M ( k ) = 1 & if ξ ( k ) \leq TH\end{matrix} \qquad ( 3 )$$

According to Equation (3), in case the estimated error ξ(k) is larger than the pre-set threshold TH, which indicates a Kₜₕ sub-carrier is distorted, the weighting coefficient M(k) of the frequency-domain notch filter 325 should be set at no less than 0 and smaller than 1; in other words, the weighting coefficient M(k) of the Kₜₕ sub-carrier is lowered. In comparison, in case the estimated error ξ(k) is smaller than the pre-set threshold TH, which indicates a Kₜₕ sub-carrier is not distorted,

the weighting coefficient M(k) of the frequency-domain notch filter 325 should be set as 1; in other words, the frequency-domain notch filter 325 imposes no influence on the Kₜₕ sub-carrier.

On the other hand, the weighting coefficient M(k′) of a K'th sub-carrier that is adjacent to the Kₜₕ sub-carrier of the frequency-domain notch filter 325 can be written:

$$\{ \begin{matrix}0 \leq M ( {k}^{′} ) < 1 & if ξ ( k ) > TH \\ M ( {k}^{′} ) = 1 & if ξ ( k ) \leq TH\end{matrix} \qquad ( 4 )$$

According to Equation (4), in case the estimated error ξ(k) is larger than the pre-set threshold TH, the weighting coefficient M(k′) of the frequency-domain notch filter 325 should be set at no less than 0 and smaller than 1; in other words, the weighting coefficient M(k′) of the K′ₜₕ sub-carrier is lowered. In comparison, in case the estimated error ξ(k) is smaller than the pre-set threshold TH, the weighting coefficient M(k′) of the frequency-domain notch filter 325 should be set as 1; in other words, the frequency-domain notch filter 325 imposes no influence on the K′ₜₕ sub-carrier.

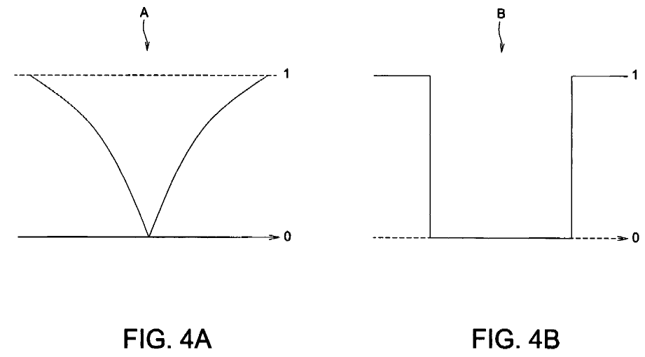

Note that, when the weighting coefficients M(k) and M(k′) are set at no less than 0 and smaller than 1, the waveform A corresponding to this setting is depicted in FIG. 4A; in comparison, when the weighting coefficients M(k) and M(k′) are set as 1, the waveform B corresponding to this setting is depicted in FIG. 4B.

Then, the frequency-domain notch filter 325 outputs a notched frequency-domain signal Y′(f), and the notched frequency-domain data Y′(n,k) or Y′(n,k′) of each sub-carrier of the notched frequency-domain signal Y′(f) can be written:

Y′(n,k)=M(k)Y(n,k) (5)

Y′(n,k′)=M(k′)Y(n,k′) (6)

Thus, when the frequency-domain data Y(n,k) or Y(n,k′) of each sub-carrier are distorted, the frequency-domain notch filter 325 may adjust the weighting coefficient M(k) or M(k′) to lower the weight of the distorted frequency-domain data Y(n,k) or Y(n,k′). Hence, the circuit for subsequent treatment may receive processed notched frequency-domain data Y′(n,k) or Y′(n,k′) rather than frequency-domain data Y(n,k) or Y(n,k′) having been influenced by co-channel interference.

Through the design of the invention, the CCI detector 326 of the OFDM receiver 3a may effectively detect whether or not the co-channel interference exists in a sub-carrier, and the weight of a distorted sub-carrier (channel) and/or the weight of its adjacent possibly distorted sub-carrier (channel) are decreased to eliminate the influence of the co-channel interference.

Moreover, the circuit operations of the OFDM receiver 3a for subsequent treatments are briefly described by taking the treatment of the notched frequency-domain data Y′(n,k) as an example.

Referring to FIG. 3C, first, the channel estimator 328 fetches the notched frequency-domain data Y′(n,k) and estimates a channel parameter H′(n,k) according to the scatter pilots contained in the notched frequency-domain data Y′(n,k). The channel parameter H′(n,k) is given by:

H′(n,k)=Y′(n,k)/C(n,k)≈M(k)H(n,k) (7)

Then, the channel estimator 328 interpolates all of the channel parameters H′(n,k) of frequency domain by its embedded interpolator and outputs the processed channel parameter H′(n,k) to the match filter 327.

To improve the reception performance of the DVB-T receiver 32, it is necessary to derive reliable soft-decision metrics from demodulated data fed to the Viterbi decoder 330. In that case, the processed channel parameters H′(n,k) should be fed to the match filter 327. The match filter 327 receives the notched frequency-domain data Y′(n,k) and generates a matched output signal H′*(n,k)Y′(n,k) according to the processed channel parameters H′(n,k). The function of the matched output signal H′*(n,k)Y′(n,k) can be written:

H′*(n,k)Y′(n,k)=M²(k)(|H(n,k)|²C(n,k)+H*(n,k)I(n,k)) (8)

The soft demapper 329 receives the matched output signal H′*(n,k)Y′(n,k) and performs symbol mapping on the matched output signal H′*(n,k)Y′(n,k) to generate an output signal O. Because the matched output signal H′*(n,k)Y′(n,k) contains the channel reliability, we can get the bit decision metric value mₖ of the Kₜₕ sub-carrier from the soft demapper 329. Finally, the output signal O are decoded by the Viterbi decoder 330, and the output data OD of the Viterbi decoder 330 are further decoded by the RS decoder 331 to obtain decoded data DDA′, which are free from the influence of the co-channel interference.

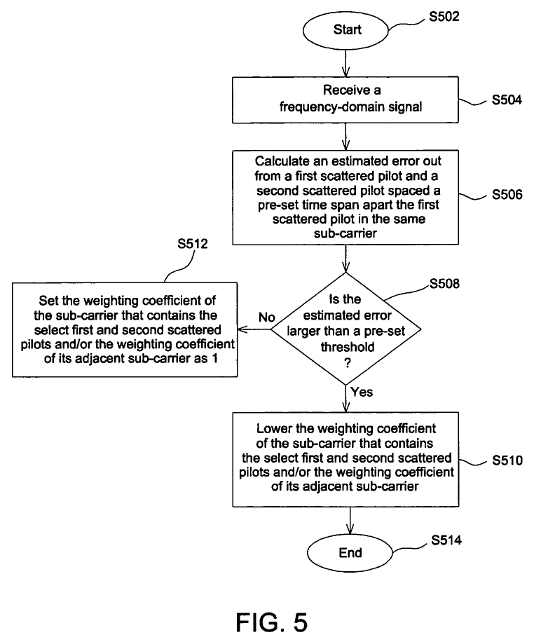

FIG. 5 shows a flowchart illustrating a method for detecting the co-channel interference (CCI). The method includes the steps described below.

Step S502: Start.

Step S504: Receive a frequency-domain signal that comprises a plurality of sub-carriers in frequency-domain.

Step S506: Calculate an estimated error out from a first scattered pilot and a second scattered pilot spaced a pre-set time span apart the first scattered pilot in the same sub-carrier.

Step S508: Determine whether the estimated error is larger than a pre-set threshold. If no, go to step S512; if yes, go to the next step.

Step S510: Lower the weighting coefficient of the sub-carrier that contains the select first and second scattered pilots and/or the weighting coefficient of its adjacent sub-carrier.

Step S512: Set the weighting coefficient of the sub-carrier that contains the select first and second scattered pilots and/or the weighting coefficient of its adjacent sub-carrier as 1.

Step S514: End.

Please note, in step S510, the weighting coefficient of the sub-carrier that contains the select first and second scattered pilots and/or the weighting coefficient of its adjacent sub-carrier may be set at no less than 0 and smaller than 1. Further, the estimated error may be an average of multiple error values calculated out from a select scattered pilot and any scattered pilot spaced the pre-set time span apart the select scattered pilot.

While the invention has been described by way of example and in terms of the preferred embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An orthogonal frequency division multiplexing (OFDM) receiver, comprising:
a co-channel interference (CCI) detector for receiving a frequency-domain signal that comprises a plurality of sub-carriers in frequency-domain and for generating an estimated error, wherein the sub-carriers comprises a plurality of scattered pilots, and the estimated error is calculated out from a first scattered pilot and a second scattered pilot spaced a pre-set time span apart the first scattered pilot in the same sub-carrier, with the estimated error being compared with a pre-set threshold to generate a comparison result; and
a frequency-domain notch filter for receiving the frequency-domain signal and generating a notched frequency-domain signal according to the comparison result, wherein the notched frequency-domain signal has a plurality of sub-carriers, and each sub-carrier contains notched frequency-domain data;
wherein, when the estimated error is larger than the pre-set threshold, the frequency-domain notch filter lowers the weighting coefficient of the sub-carrier that contains the select first and second scattered pilots and/or the weighting coefficient of its adjacent sub-carrier, while the frequency-domain notch filter sets the weighting coefficient of the sub-carrier that contains the select first and second scattered pilots and/or the weighting coefficient of its adjacent sub-carrier as 1 when the estimated error is smaller than the pre-set threshold.

2. The OFDM receiver as claimed in claim 1, further comprising a discrete Fourier transform circuit for receiving an input signal that comprises a plurality of sub-carriers in time domain and for generating the frequency-domain signal.

3. The OFDM receiver as claimed in claim 1, wherein the frequency-domain notch filter sets the weighting coefficients at no less than 0 and smaller than 1 when the estimated error is larger than the pre-set threshold.

4. The OFDM receiver as claimed in claim 1, wherein the CCI detector comprises:
a calculator for evaluating the estimated error; and
a CCI comparing unit for comparing the estimated error with the pre-set threshold to generate the comparison result.

5. The OFDM receiver as claimed in claim 1, wherein the estimated error equals the square of the absolute value of the difference between a first frequency-domain data and a second frequency-domain data that respectively contain the first and the second scattered pilots.

6. The OFDM receiver as claimed in claim 1, wherein the estimated error is an average of multiple error values calculated out from a select scattered pilot and any scattered pilot spaced the pre-set time span apart the select scattered pilot.

7. The OFDM receiver as claimed in claim 1, further comprising a channel estimator for fetching the notched frequency-domain data and generating a processed channel parameter according to the scattered pilots contained in the notched frequency-domain data.

8. The OFDM receiver as claimed in claim 7, further comprising a match filter for receiving the notched frequency-domain data and generating a matched output signal according to the processed channel parameter.

9. The OFDM receiver as claimed in claim 8, further comprising a soft demapper for receiving the matched output signal and performing symbol mapping on the matched output signal to generate an output signal.

10. The OFDM receiver as claimed in claim 9, further comprising a Viterbi decoder for decoding the output signal of the soft demapper.

11. The OFDM receiver as claimed in claim 9, further comprising a RS decoder for decoding the output signal of the soft demapper.

12. The OFDM receiver as claimed in claim 1, wherein the first and the second scattered pilots are in different symbols.

13. The OFDM receiver as claimed in claim 1, wherein the OFDM receiver is used in a digital video broadcasting-terrestrial (DTV-T) system.

14. An orthogonal frequency division multiplexing (OFDM) receiver, comprising:
a co-channel interference (CCI) detector for receiving a frequency-domain signal that comprises a plurality of sub-carriers in frequency-domain and calculating an estimated error out from a first scattered pilot and a second scattered pilot spaced a pre-set time span apart the first scattered pilot in the same sub-carrier; and
a frequency-domain notch filter for adjusting the weighting coefficient of the sub-carrier that contains the select first and second scattered pilots and/or the weighting coefficient of its adjacent sub-carrier according to the estimated error.

15. The OFDM receiver as claimed in claim 14, wherein, when the estimated error is larger than a pre-set threshold, the frequency-domain notch filter lowers the weighting coefficient of the sub-carrier that contains the select first and second scattered pilots and/or the weighting coefficient of its adjacent sub-carrier, while the frequency-domain notch filter sets the weighting coefficient of the sub-carrier that contains the select first and second scattered pilots and/or the weighting coefficient of its adjacent sub-carrier as 1 when the estimated error is smaller than the pre-set threshold.

16. The OFDM receiver as claimed in claim 14, wherein, the frequency-domain notch filter sets the weighting coefficient of the sub-carrier that contains the select first and second scattered pilots and/or the weighting coefficient of its adjacent sub-carrier at no less than 0 and smaller than 1 when the estimated error is larger than the pre-set threshold.

17. The OFDM receiver as claimed in claim 14, wherein the estimated error is an average of multiple error values calculated out from a select scattered pilot and any scattered pilot spaced the pre-set time span apart the select scattered pilot.

18. A method for detecting the co-channel interference (CCI), comprising the steps of:
receiving a frequency-domain signal that comprises a plurality of sub-carriers in frequency-domain;
calculating an estimated error out from a first scattered pilot and a second scattered pilot spaced a pre-set time span apart the first scattered pilot in the same sub-carrier; and
adjusting the weighting coefficient of the sub-carrier that contains the select first and second scattered pilots and/or the weighting coefficient of its adjacent sub-carrier according to the estimated error.

19. The detection method as claimed in claim 18, wherein, when the estimated error is larger than a pre-set threshold, the weighting coefficient of the sub-carrier that contains the select first and second scattered pilots and/or the weighting coefficient of its adjacent sub-carrier is lowered; while the weighting coefficient of the sub-carrier that contains the select first and second scattered pilots and/or the weighting coefficient of its adjacent sub-carrier is set as 1 when the estimated error is smaller than the pre-set threshold.

20. The detection method as claimed in claim 18, wherein, when the estimated error is larger than the pre-set threshold, the weighting coefficient of the sub-carrier that contains the select first and second scattered pilots and/or the weighting coefficient of its adjacent sub-carrier is set at no less than 0 and smaller than 1.

21. The detection method as claimed in claim 18, wherein the estimated error is an average of multiple error values calculated out from a select scattered pilot and any scattered pilot spaced the pre-set time span apart the select scattered pilot.
